(19) United States
(12) Patent Application Publication
(10) Pub. No.: US 2018/0142436 A1
(43) Pub. Date: May 24, 2018

(54) ROAD SIGNS

(71) Applicant: Sarkis Agajanian, Los Angels, CA (US)

(72) Inventor: Sarkis Agajanian, Los Angels, CA (US)

(21) Appl. No.: 15/822,068

(22) Filed: Nov. 24, 2017

Related U.S. Application Data
(60) Provisional application No. 62/426,105, filed on Nov. 23, 2016.

(51) Int. Cl. E01F 9/615; E01F 9/688; E01F 9/30; G08G 1/14

(52) U.S. Cl. CPC E01F 9/615; G08G 1/146; E01F 9/30; E01F 9/688

(57) ABSTRACT

The present invention relates to a plurality of road signs, and in particular, a lighting system using a plurality of road signs, where the lights are remotely activated or deactivated based on a temporal road condition. The lights may be further activated or deactivated by presence of a maintenance or emergency vehicle where the vehicle transmits a signal either directly or indirectly to a receiver on the sign that may activate or deactivate the lighting system.

### FIELD OF THE INVENTION

The present invention relates to systems for signaling, marking, or indicating road conditions, namely, using indicator systems and status update systems to signal, mark, or indicate hazards, warnings, restrictions or other types of road conditions.

### BACKGROUND OF THE INVENTION

Lights and words on a sign are traditionally used to indicate road conditions such as hazards, warnings, or restrictions. Examples of such indicators include traditional signage, variable message signs, warning beacons, and traffic lanterns. These indicators may employ matrix displays, flip disks, light emitting diodes, or fiber optics to indicate a hazard, warning, restriction, or condition as embodied in variable message signs disclosed in U.S. Pat. Nos. 3,975,728, 4,680,883, 4,040,193, 5,715,619, 6,088,008, 6,204,778. Many of these different types of indicators may be preprogrammed or controlled remotely as further shown in U.S. Pat. No. 6,204,778. For example, many municipalities use traditional signage to convey hazards, warnings, restrictions, or conditions. Sometimes multiple signs are used on a single post to convey different road conditions whether it is driving conditions or parking conditions. Multiple interacting restrictions may cause confusion and in some cases road hazards. Furthermore, prior indicators that can provide multiple signage are not versatile enough to be deployed in various contexts (e.g. multiple interacting signage restrictions) because they are either too bulky; lack processors and/or logic necessary to generate specific hazards, warnings, restrictions, or other conditions. Prior road sign indicators lack certain remote or local control mechanisms, or lack design features for widespread use in certain areas.

Another unsolved problem is that parking restriction signs limit parking for an extended time period which causes reduced parking, increased traffic congestion, and limited access to public facilities. Such parking limitations may only be needed until certain road activities are completed such as street sweeping. If the task is complete, then the parking restriction should be immediately lifted. A system capable of allowing immediate lifting of a parking restrictions along a roadway would allow the public to park in that location soon after.

Emergency vehicles often signal their approach to other users of a roadway behind which is not always recognized by the other users. A system that can provide notice of the approaching emergency vehicles in advance would greatly reduce the chance of accidents or delays to the emergency vehicles.

### INVENTION SUMMARY

The present invention relates to systems for signaling, marking, or indicating, namely using indicator systems and status update systems to signal, mark, or indicate road conditions such as driving or parking hazards, warnings, restrictions or other conditions. The indicator system may illuminate or otherwise use visual stimulus for indicating a hazard, warning, restriction, or condition. The indicator system may have one or more central processing units (CPUs), power sources, control circuits, or controllers to manually or automatically control aspects. These indicator systems may be used in a status update system. The status update system may have one or more indicator systems which have status or diagnostic data generation methods and information retrieval methods. The information retrieval methods may use a content server which may deliver diagnostic or status data to a client. Upon receiving diagnostic or status data, the client may render the delivered data (e.g. via a display) to visualize or analyze the diagnostic or status information. In one embodiment, a client may render the delivered data into a geographic map with various marks or symbols representing real-time hazards, warnings, restrictions, or other conditions being indicated by various indicator systems.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

These and other features of this invention will be best understood by reference to the following detailed description preferred embodiments of the invention, taken in conjunction with the accompanying drawings, in which:

FIG. 1 is a perspective view of an exemplary embodiment of an indicator system.

FIG. 2 is a diagram of an indicator system in accordance with some embodiments of the present invention.

FIG. 3 is a diagram of a status update system in accordance with some embodiments of the present invention.

FIG. 4 is a perspective view of another exemplary embodiment of an indicator system.

FIG. 5 is a perspective view of another exemplary embodiment of an indicator system.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF THE PREFERRED EMBODIMENTS

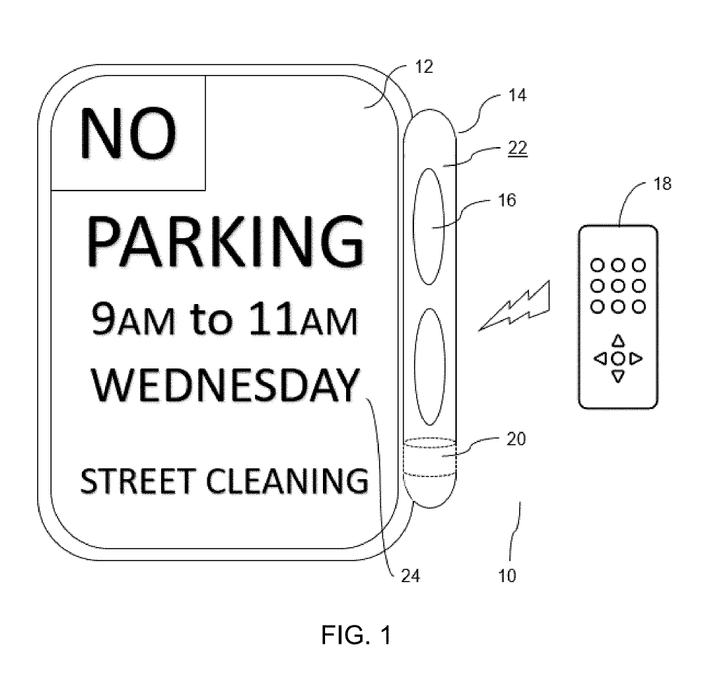

FIG. 1 is an exemplary embodiment of an indicator system 10, which in this case is an indicator system for a municipal street sweeping sign 12. The indicator unit 14 may alternatively be configured for left/right turn only areas or directional road access with temporal conditions or any other areas where it is imperative to convey restrictions or other conditions to people.

In the exemplary embodiment in FIG. 1, the indicator unit 14 may have one or more aspects 16 for indicating whether the no parking restriction 24 is in effect. As discussed in more detail below, the aspects 16 may illuminate red to indicate the no parking restriction is in effect or green to indicate the no parking restriction is not in effect. In the exemplary embodiment, a street sweeper operator or other authority may activate or deactivate the aspects 16 with a transmitter 18 prior to the listed end of the time period for the parking restriction 24 when the street sweeper operator is finished sweeping in order to allow people to park in these parking spaces at an earlier time.

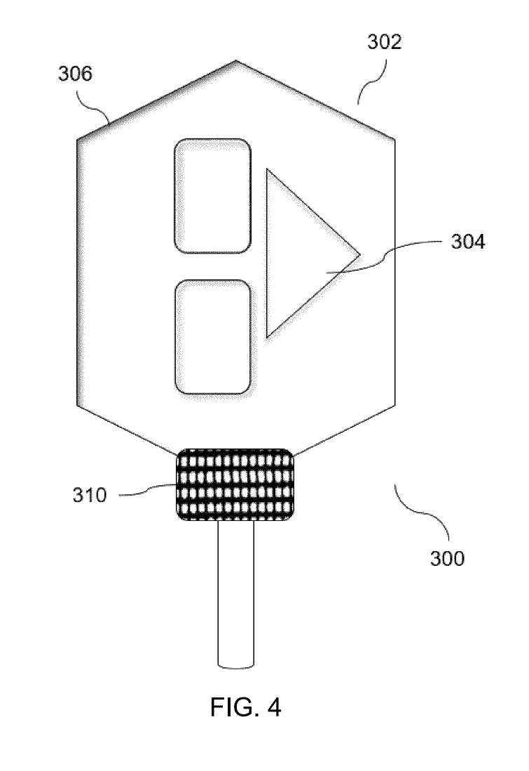

FIG. 4 is exemplary embodiment of an indicator system 300, which is an indicator system for highways or freeways. The indicator system 300 has an indicator unit 302 which may be located in a center median of a roadway and may have one or more aspects 304 to warn drivers to be cautious of dangerous conditions such as fog, rain, blizzards, bears, accidents, etc. In this embodiment, the aspects 304 may be controlled via an on-board controller or a remote controller. Remote controllers may be through a hard-wired communication system or wireless based system including cloud messaging systems.

One or more indicator units may be used in a status update system, which allows the indicator units to communicate diagnostic or status information to a content server such as which hazard, warning, restriction, or condition is being displayed at any given time. The content server may also deliver diagnostic or status information to one or more clients. One or more clients may have a display for rendering the diagnostic or status information as a geographic map with marks or symbols representing diagnostic or status information from one or more indicator units.

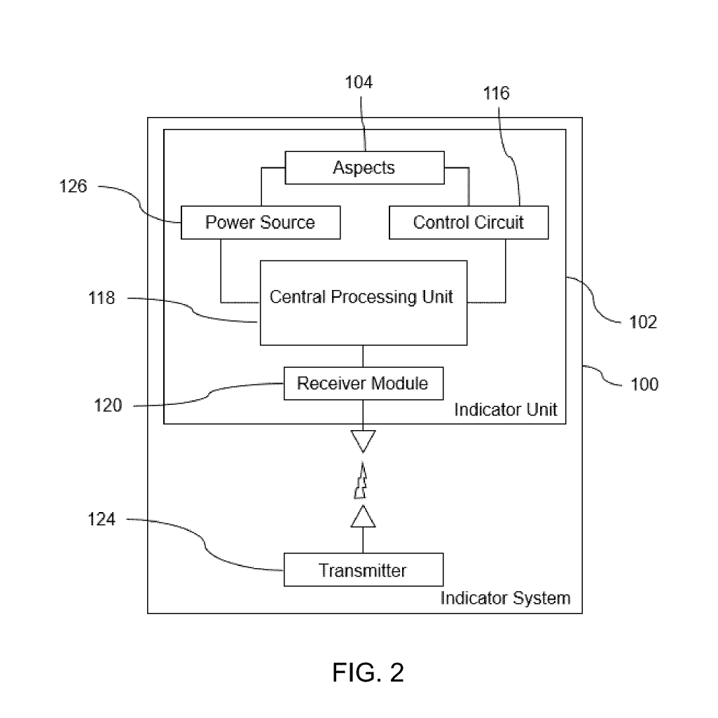

FIG. 2 is a block diagram of an indicator system 100 in accordance with some embodiments of the present invention. Indicator system 100 may have an indicator unit 102 with one or more aspects 104. The one or more aspects 104 indicate a warning, hazard, restriction or condition. In preferred embodiments, aspect 104 may illuminate to indicate a warning, hazard, restriction or condition. In one embodiment, aspect 104 has one or more lamps 112 which may have wattage that is similar to those used in traffic lanterns. In another embodiment, aspect 104 has one or more clusters of solid-state diodes which form pixels for a variable message sign or a bulb. In the case of a variable message sign, the aspects 104 may spell out a message in various colors such as “NO PARKING” spelled out by red solid-state diodes. It is to be appreciated that aspect 104 may have any number of LEDs for such reasons as to conserve power or to increase luminance. It should also be appreciated that the LEDs may be configured in any pattern or arrangement. In another embodiment, aspect 104 may be an LED, liquid crystal, plasma, or other type of display. In other embodiments, aspect 104 may have halogen capsules, halogen or LED spotlights, fluorescent or LED tubes, push fit light bulbs or compact fluorescent lamps, or other known illuminating elements. In preferred embodiments, one or more aspects 104 may face multiple directions in a 360 degree range to create a bidirectional or omnidirectional display. In some embodiments, aspects may indicate through mechanical means, such as a red engineer grade reflective panel which reveals itself to convey a warning, hazard, restriction or condition. In other embodiments, one or more aspects 104 may illuminate while others may employ mechanical means. It should be appreciated that the following examples and embodiments may be configured with illuminating aspects 104 and/or other envisioned types of aspects.

Aspects 104 may also have a light-transmitting cover. In one embodiment, the light-transmitting cover is transparent. Alternatively, the cover may be translucent, colored, or frosted. In one embodiment, the light-transmitting cover is smooth. In alternative embodiments, the cover may be etched or otherwise textured. The etching, texture or translucent portions may form visible indicators such as, but not limited to, words, symbols or arrows. The light-transmitting cover may have any desired shape. The overall shape may also serve as an indicator. In one exemplary embodiment, one or more aspects 104 have a light-transmitting cover similar to a strobe or other warning beacon traditionally used to indicate road hazards.

In some embodiments, indicator unit 102 may include one or more control circuits 116 for controlling one or more aspects 104. In some embodiments, control circuits 116 may effectuate transitioning one or more aspects 104 to an on state, an off state, etc. Further, the control circuit may strobe one or more illuminating aspects (e.g., periodically turning illuminating elements on and off with substantially any periodicity). Any given control circuit may control a single aspect 104 or multiple aspects 104. In other embodiments, the indicator unit 102 may include a central processing unit 118 (CPU) which controls the one or more aspects 104 via electrical connections to control circuits 116. The CPU 118 may generally have a control unit, an ALU, a memory management unit (with RAM and ROM), a clock, and input and output circuitry. The CPU 118 may be programmed to control the aspects 104 based on preprogrammed times, conditions, or other events. In an exemplary embodiment in FIG. 1, the CPU 118 may be programmed to illuminate an array of green aspects when a no parking restriction is not in effect and illuminate an array of red aspects when a no parking restriction is indeed in effect. In one exemplary embodiment in FIG. 4, the CPU may be programmed to illuminate a yellow flashing light in a school zone to indicate to drivers that it they should proceed with caution. In another embodiment, the CPU may be programmed to turn an array of aspects 104 off during daylight hours.

On the other hand, one or more aspects 104 may be controlled via one or more manual controllers 120, as opposed to an automatic controller such as a CPU. Manual controllers may be useful for activating or deactivating certain aspects 104 when warnings, hazards, restrictions, or conditions should begin or be terminated outside of normal operating conditions. In the exemplary embodiment in FIG. 1, a maintenance vehicle such as a street sweeper could have a transmitter that would activate and/or deactivate the illuminating elements upon completing the task such as sweeping of a portion of the street. Other maintenance vehicles include garbage trucks, snow plows, delivery cars, or postal cars, power line vehicles, construction vehicles, or any other vehicles that require parking to be temporarily restricted. The vehicle would have a transmitter that emits a signal either directly to the signs or indirectly to a central control hub. The central hub may possibly receive a GPS signal of the vehicle and then send as signal to the road signs to deactivate the lights on the sign. The road signs would have a receiver that receives the signal deactivates the light, and thus the road condition. The lights and signs may also be in the form of a digital display that changes text or symbols upon the road condition being changed.

Such immediate change of the road condition's parking restriction may free up parking spaces earlier than the posted expiration time of the “no parking” restriction. The parking restriction signs may be activated by a timer for the duration of the normal parking restriction. The lights that are activated by the timer would signal that the parking restriction is in force. The street sweeper may have a transmitter that either manually or automatically emits a signal to the receiver on the sign to deactivate the lights that indicate that the parking restriction is in force. The sign may also have an additional set of lights to indicate that parking is allowed. Such lights may be activated by the street sweeper sending a signal to activate such lights. The signal to active “parking is allowed” lights may be a separate signal that deactivates the “no parking” lights or the signal may be same signal.

In another exemplary embodiment in FIG. 4, a police or other emergency vehicle may remotely activate or deactivate a light to instruct drivers to move from the lane designated for emergency vehicle access. The sign or lights (e.g. a red flashing arrow) may further indicate that the drivers should move to particular lane so as to allow emergency vehicles to pass. An emergency vehicle may be from the police, fire department, hospital, or other entities that require emergency access to the lane. A plurality of the emergency signs or lights may be located along a stretch of highway. The emergency vehicle may activate some or all the signs before the emergency vehicle its arrival. The activation of the emergency signs may be limited to the proximity of the approaching vehicle. The vehicle would have a transmitter that emits a signal either directly or indirectly to the emergency signs. Indirect communication may be through a central hub that monitors the GPS signal of the vehicle and sends a signal to the signs based on the vehicles locations.

Other drivers and users of the roads would be notified of the approaching emergency vehicle in advance and they could make room for the approaching emergency vehicle in a more safe and efficient manner. As the emergency vehicle or vehicles pass each emergency sign, the emergency sign may be deactivated or activated to indicate that the roadway is clear for general traffic. The sign may have for example red flashing lights to indicate the coming approach of an emergency vehicle and a green light to indicate that the roadway is clear for general traffic. The flashing warning lights may be activated remotely along a path of the emergency vehicle. As the emergency vehicle(s) passes by a flashing sign, the lights may be remotely switched either manually or automatically as the emergency vehicle passes the sign.

Emergency lights may also have lights that indicate hazardous road conditions such as fog, rain, hail, sleet, snow or any other dangerous environmental condition. The lights may flash yellow. As the environmental condition passes, the road signs may automatically deactivate the lights for such a road condition. Signs may be equipped with humidity detectors, fog detectors, or other environmental sensors.

In some embodiments, indicator unit 102 may have a manual controller 120 directly coupled to the indicator unit 102. In a preferred embodiment, one or more aspects 104 may be activated or deactivated via a switch located directly on the indicator unit 102. In one embodiment, the switch may be electrically connected to the CPU 118. The CPU 118 may further employ preprogrammed logic to control the one or more aspects 104 via one or more control circuits 116. In another embodiment, the switch may be directly connected to one or more control circuits 116 to activate or deactivate one or more aspects 104. The indicator unit 102 may employ other switch configurations to control one or more aspects 104. Types of switches may include, but are not limited to, a tact switch, toggle switch, a paddle switch, a slide and push switch, a DIP switch, a membrane switch which includes a push button, a biased switch, a rotary switch, a reed switch, an illuminated switch, a micro-switch that is responsive to movement, and radio frequency identification (RFID) based switch or any other remote switches. Push buttons may range from a “mini” to sub-miniature pushbutton switch, or to smaller sizes such as an ultra-miniature micro tact switch. Other possible manual controllers which can be directly connected to the indicator unit 102 include, but are not limited to touch displays, arrays of buttons, or keyboards

In other embodiments, one or more aspects 104 may be activated by manual controllers employing remote communications. Possible methods of remote communication may include wired or wireless communications. Possible mediums of wired communication include, but are not limited to, copper cables, coaxial cables or fiber optic cables. Possible means of wireless communication include, but are not limited to, infrared, micro, or radio waves. In some embodiments, the indicator unit 102 may be wired directly to a municipality's main frame for remotely controlling (albeit manually) or monitoring an indicator system 100 at a remote location. In a preferred embodiment, indicator unit 102 may include a receiver module 122. The receiver module 122 may be electrically or otherwise connected to the CPU 118 via one or more input circuits. The receiver module may alternatively be electrically connected to the CPU 118 via a relay. The receiver module 122 may include an antenna for receiving a carrier signal from a transmitter 124 and a demodulator for demodulating the carrier signal. The receiver module 122 may have a separate processor for processing the demodulated carrier signal or it may employ the indicator unit CPU 118 for the same. In other embodiments, the receiver module 122 may also include a transmitter module for transmitting a carrier signal back to transmitter 118. The indicator unit 102 may employ other remote control circuits and methods known in the art.

The indicator unit 102 may have one or more power sources 126 for powering one or more aspects 104, CPU 118, receiver module 122, and/or control circuits 116. In a preferred embodiment, one or more of the power sources 126 may be hard-wired or by a direct power source (e.g. battery). Power sources include, but are not limited to solar cells, hydrogen fuel cells, methanol fuel cells, radio frequency harvesting power sources or any other power source which harvests energy; alkaline batteries; nickel-cadmium batteries; rechargeable batteries; capacitors or arrays of capacitors acting as batteries or other known power sources. It should be understood that any number or combination of known power sources may be used depending on size, power, and back-up power requirements.

In other embodiments, the indicator unit 102 may include an integrated circuit containing a CPU; one or more control circuits; a receiver, transmitter, or transceiver module; one or more power sources; or other indicator unit components or combinations thereof.

An indicator unit 14 may have a central housing 20 to house one or more indicator unit components. The central housing 20 may be constructed of die cast aluminum, aluminum alloy (e.g. AlMg3), stainless steel or any other known materials. In the exemplary embodiment in FIG. 1, the central housing 20 is generally cylindrically shaped and may house one or more control circuits 116, a CPU 118, a receiver module 122, one or more power sources 126, and any other desired indicator unit components. In other embodiments, the central housing may have any desired shape suitable for housing any number of indicator unit components (i.e. a pyramid shape, ellipsoid shape, box, etc.). The one or more indicator unit components may be secured within the central housing 20. Possible means of securing the one or more indicator unit components include, but are not limited to: screws, nails, magnets, flanged heads, fasteners, welding, or soldering. In a preferred embodiment, the central housing 20 may have one or more circuitry apertures to accommodate electrical connections between indicator unit components inside the central housing and any indicator unit components without the central housing. In the exemplary embodiment in FIG. 1, central housing 20 may have an aperture disposed within the upper surface for electrical connections between aspects 16 and the one or more power sources which may be housed within the central housing 20 and/or an electrical connection between the one or more control circuits housed within the central housing 20 and aspects 16.

In a preferred embodiment, the indicator unit 14 has a housing 22. Housing 22 may also be constructed of die cast aluminum, aluminum alloy (e.g. AlMg3), stainless steel, plastic or any other known materials or methods of manufacture. In the exemplary embodiment in FIG. 1, the housing 22 is an oblong strip or cylinder with rounded ends. In the exemplary embodiment in FIG. 4, the housing 306 may be shaped like a hexagon. It is to be appreciated that the housing 22 may be any size and/or shape and is not limited to the depicted illustration (e.g., the housing 22 can be dome shaped, pyramid shaped, or cylindrical).

Housing 22 may have one or more apertures for one or more aspects 16. In some embodiments, the housing 22 may have one or more interior casings for coupling one or more illuminating elements. In the exemplary embodiment, the housing 22 has an interior parabolic casing with a fitting near the focal point for receiving the base of an illuminating element or other type of aspect. It is to be appreciated that the casing may be any other size/and or shape and is not limited to a parabolic shape (e.g., the casing can be dome shaped, pyramid shaped, or cylindrical), and one or more fittings may be positioned in other locations on the casing.

In some embodiments, the housing 22 may have a board disposed within the interior of the housing 22 for coupling various types of aspects 16. In one embodiment, a rigid or semi-rigid board is disposed within the interior of the housing and fittings for receiving illuminating elements are mounted or otherwise coupled with the board adjacent to apertures in housing 22. In other embodiments, illuminating elements may be secured to a board within housing 22 with brackets, fasteners, screws, grommets, magnets, adhesives, or other known means.

The housing 22 may include one or more design characteristics to shield any illuminating elements from incident light, damaging light (Sunlight or harmful UV radiation), restrict the angular coverage of the illuminating elements, or aim light emitted from any illuminating elements. In preferred embodiments, illuminating elements are recessed so that they are more visible in outdoor conditions. In some embodiments, housing 22 may have one or more visors secured to the housing 22 adjacent to one or more apertures. In other embodiments, housing 22 may have one or more vertical or horizontal louvres secured to the housing to further restrict angular coverage and the intensity of the illuminating elements.

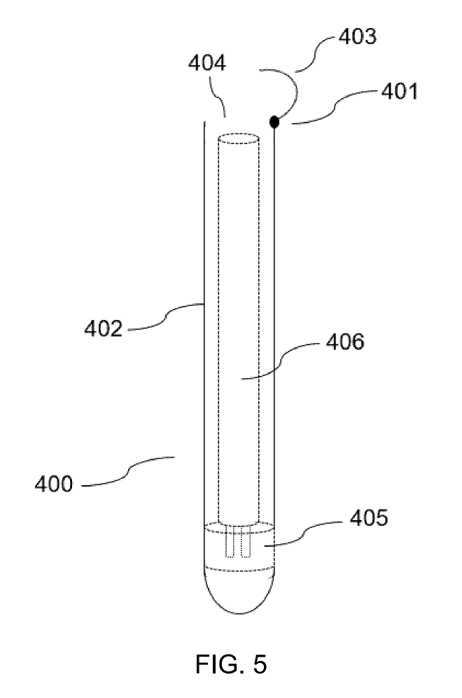

In the exemplary embodiment in FIG. 1, the housing 22 further houses the central housing 20 at one end of the housing 22, but it should be appreciated that the central housing 20 may otherwise be disposed elsewhere within the housing 20. In other embodiments, the central housing 20 may be separate from the housing 22 so that the aspects 16 may be completely separate from the central housing. The aspects 16 may be controlled via remote communications between indicator unit components within the central housing 16 and indicator unit components within the housing 20. In the exemplary embodiment in FIG. 5, a disposable light 406, which in this case may be a fluorescent tube, may be inserted into a housing 402 through an opening 404. The disposable light may be halogen capsules, halogen or LED spotlights, fluorescent or LED tubes, push fit light bulbs or compact fluorescent lamps, or other known illuminating elements. The opening 404 may be covered by a door 403. The door 403 may have a hinge 401. In the exemplary embodiment n FIG. 5, the fluorescent tube 406 may be locked into place by prongs inserted into a base within the central housing 405. In other embodiments, the disposable light may be locked into place by fasteners, twist fittings coupled to a base, or other known locking mechanisms. In other embodiments, disposable light 406 may be a plastic tube with illuminating elements disposed within the interior of the plastic tube. The plastic tube may be similarly locked into place. The fittings or other illuminating elements may be electrically connected to the control circuits 116.

Indicator unit 14 may have a means for securing it to a street sign or within or surrounding other areas requiring indicating. In the exemplary embodiment in FIG. 1, the housing 22 is secured to the municipal street sweeping sign using an adhesive. The adhesive may be a polyvinyl acetate based glue, cement, or other known adhesives. In the exemplary embodiment in FIG. 4, housing 306 may secured to a post and cemented into the ground. In other embodiments, the indicator unit 14 may be secured using screws, nails, suction cups, magnets, VELCRO, flanged heads, or fasteners. In other embodiments, indicator unit 306 may be secured to a portable unit such as a trailer.

An indicator unit may also have a coms unit 308 for engaging in voice or video communications in the event of an emergency. The coms unit 308 has electrical means for either recording, transmitting, or receiving voice or video data. In some embodiments, coms unit 308 may be housed in a coms box 310 which may be separate from the housing 306. In other embodiments, the coms unit 308 may be housed within housing 306. In the case of the former, the coms box 310 may be secured on or around the indicator unit 302. The coms housing 310 may be secured on or around the indicator unit 302 with screws, nails, suction cups, magnets, VELCRO, adhesives, flanged heads, fasteners, or other means known in the art. In the case of a coms unit 308 secured within housing 306, the coms unit may be accessible through a hinged door in a rear portion of the housing 306. In some embodiments, coms unit 308 may have a call button which is preprogrammed to initiate communications with a predetermined device that is capable of engaging in voice or video communications such as a 911 dispatch. In other embodiments, coms unit 308 may have a dial pad which a user may utilize to initiate communications with a device of their choosing that is also capable of engaging in voice or video communications.

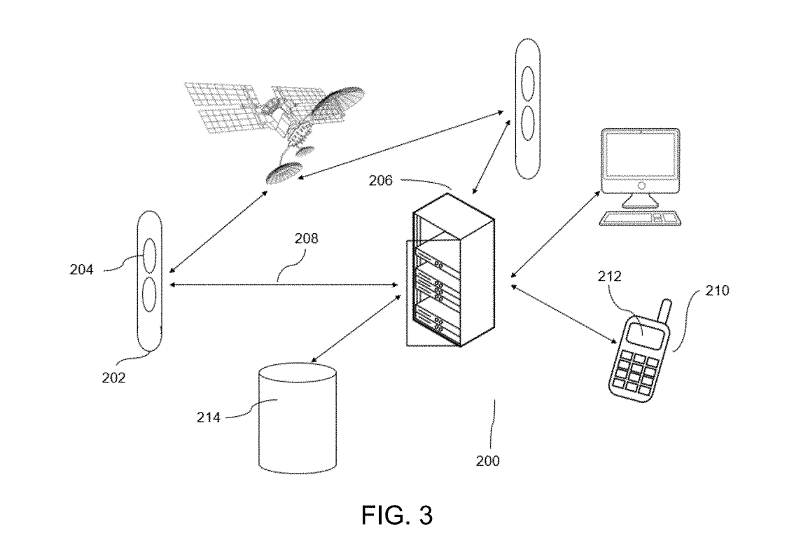

As depicted in FIG. 3, one or more indicator units 202 may be used in a status update system 200. Generally, a status update system generates data representing diagnostic or status information about an indicator unit 202 and either stores the data locally or transmits the data to a content server 206. Diagnostic and status information include, but are not limited to the working condition of indicator unit components (e.g. whether a power source needs to be replaced), state information (e.g. whether an illuminating element is illuminated to indicate a certain restriction or condition), location data (e.g. Global Positioning System data), or error data (e.g. troubleshooting information). It should be understood that the indicator unit 202 may transmit additional data to assist in routing and transmitting the diagnostic or status data, including, but not limited to metadata, data specific to underlying transmission protocols, identifying information (e.g. a unique identifier for determining which indicator unit any transmitted diagnostic or status information pertains to), or other similar data. Diagnostic and status information may be useful to monitor the state of hardware or software of one or more indicator units 202, and status information may be particularly useful for viewing and/or analyzing various indications (i.e. indicated warnings, hazards, restrictions or conditions) over a geographic area.

The status update system 200 has one or more indicator units 202 with status or diagnostic data generation modules. In one embodiment, indicator unit 202 may be configured to have an on-board diagnostic circuit such as a serial scan chain. In another embodiment, a CPU of an indicator unit 202 may be programmed to run a diagnostic program which detects faults in the indicator unit 202 logic or hardware. Indicator unit 202 may generally have any diagnostic data generation modules known to those in the art, such as other circuit fault detection methods. Status data generation modules may include, but are not limited to programs or hardware which detect the state of various light unit components (e.g. how or whether an indicator unit 202 is indicating). Status data generation modules may utilize resources from one or more diagnostic data generation modules or use separate hardware or logic to generate status information. In one embodiment, the status data generation module may be where a CPU of an indicator unit 202 fetches data from memory after it is stored by a serial scan chain method. In another embodiment, the status data generation module may be where a CPU employs further logic to store data representing state changes of the indicator unit 202. One or more indicator units may use existing resources of the indicator unit 202 or use separate hardware and/or logic to generate location data pertaining to one or more indicator units 202. In one embodiment, a CPU of an indicator unit 202 may have further logic to program a unique identifier and/or other locator or identification data into memory. In another embodiment, the indicator unit 202 may have a Global Positioning System (GPS) receiver comprising, generally, an RF down converter, an A/D converter, a digital signal processing section, and an antenna. A GPS receiver may also be useful for anti-theft purposes. The GPS receiver may communicate with a CPU of the indicator unit 202 via input circuits of the CPU to determine the position of the indicator unit 202. It should be understood that, a person having ordinary skill in the art may envision other methods of incorporating a location data into an indicator unit 202.

The status update system may have an information retrieval method to retrieve from the indicator unit 202 data representing status or diagnostic information. The information retrieval method may be manual or automatic.

Manual information retrieval methods may encompass manually downloading data directly from the indicator unit 202 via a separate device. The separate device may be any electronic device capable of storing binary data (e.g. a solid state flash drive or mobile phone running an application). Manual information retrieval methods may encompass downloading wirelessly or through a wired connection. In one embodiment, a USB port is electrically connected to ports of a CPU of an indicator unit 202 for a separate device to be plugged in to. Either one or both of the CPU and the separate device may run computer programs to coordinate downloading data from the indicator unit 202.

Automatic information retrieval methods may include computer initiated transmissions to a content server 206. In a preferred embodiment, the indicator system 202 has a network interface 208 which communicates diagnostic or status information to a content server 206. Network interface 208 may include one or more networks, including but not limited to, a local area network, medium-area network, and/or wide-area network, such as the Internet. Network interface 208, for example, may be any form of wired or wireless network that allows indicator unit 202 and content server 206 to communicate with each other. In one embodiment, network interface 208 may be a municipality's main frame. In another embodiment, network interface 208 may be a Bluetooth based personal area network (PAN). Bluetooth is known to those skilled in the art and is an open wireless protocol for exchanging data over short distances from fixed and mobile devices. Regardless of the type of network interface 208, indicator unit 202 may have a corresponding network interface controller which operates with a CPU to transmit data representing diagnostic or status information to a content server 206 through network interface 208. Content server 206 may include any form of geographic data, map data, astronomical data (e.g. lunar terrain) and oceanic data. Content server 206 may be a GIS server. Such a GIS server may be configured to bring images of the Earth and other geospatial data to a client. Together, the images of the Earth and other geospatial data may form a three-dimensional model in a three-dimensional environment. Content server 206 may also include audio, video, text and any other form of data. In one embodiment, content server 206 may be a database 214 or repository implemented on a server (or computing device). Such a content server 206 may be a workstation, mobile device, computer, cluster of computers, set-top box, or other device having at least one processor. Such a processing device may include software, firmware, hardware, or a combination thereof. Software may include one or more applications and an operating system. Hardware can include, but is not limited to, a processor, memory and graphical user interface display.

In a preferred embodiment, one or more clients may communicate with content server 206. For example, mobile device 210 may retrieve content from content server 206 via a network interface and display the retrieved content using a display 212. In an exemplary embodiment, status update system 200 may have a mobile device 210 which provides Hyper Text Markup Language (HTTP) requests for GIS data to content server 206 and receives HTTP responses that include the requested GIS data from content server 206. The GIS data may include vector based maps (also referred to as “map layer data” consisting of geographic information/data for one or more layers) which are an encoded and spatially indexed vector representations of geographic data. These vector based maps may embody representations of data generated by one or more indicator units 202. For example, the data may encode a satellite map of a downtown area which includes symbols or marks to represent indications or other status or diagnostic information from one or more indicator units 202. The mobile device 210 may have an application which renders the vector based maps. Such an application would be especially useful to determine parking availability in a busy urban area. It should be appreciated that the network interface 208, network layers, client device or display, nor data structures are limiting factors of the exemplary embodiment. For instance, in another example, status update system may have a client running a virtual connection to a content server 206 to retrieve data representing diagnostic information transmitted by one or more indicator units 202.

Those skilled in the art will recognize many modifications may be made to these exemplary embodiments without departing from the scope of the present invention. For example, those skilled in the art will recognize that any combination of the above components, or any number of different components, including different logic, data, different peripherals, and different devices, may be used to implement the present invention, so long as similar functions are performed thereby.

I claim:

1. A method of communicating road conditions comprising;
(a) A plurality of road signs wherein each road sign defines a road condition, and each road sign has a light wherein each light when lit, indicates that the road condition is in effect, wherein each light is connected to power source and a receiver, wherein the receiver deactivates the light upon receiving a signal;
(b) Activating all the lights is in effect; and
(c) Deactivating each light upon a vehicle being within a proximity of the sign wherein the vehicle has a transmitter and wherein the transmitter emits the signal to deactivate each light.

2. The method of claim 1 wherein the road condition is a parking restriction.

3. The method of claim 1 wherein the vehicle is a maintenance vehicle.

4. The method of claim 1 wherein the road condition is an emergency vehicle approaching.

5. The method of claim 1 wherein the vehicle is an emergency vehicle.

6. The method of claim 5 wherein the emergency vehicle activates the lights when approaching the plurality of road signs.

7. The method of claim 1 wherein the signal is emitted wirelessly.

8. The method of claim 1 wherein the lights are activated by a timer that activates the lights for a specified time period, and the lights can be deactivated before the end of the time period upon receiving the signal.

9. The method of claim 1 wherein the proximity may be a distance before the vehicle approaches the sign, at the distance of the sign along the road, or a distance after the vehicle passes the sign.
